(19) United States
(12) Patent Application Publication
(10) Pub. No.: US 2011/0199396 A1
(43) Pub. Date: Aug. 18, 2011

(54) METHOD AND APPARATUS FOR DISPLAYING IMAGE FOR SELF-LUMINESCENCE DISPLAY

(75) Inventors: Min-Woo LEE, Suwon-si (KR); Yong-Deok KIM, Suwon-si (KR); Jae-Hun CHO, Yongin-si (KR); Sung-Dae CHO, Yongin-si (KR)

(73) Assignee: Samsung Electronics Co., Ltd., Suwon-si (KR)

(21) Appl. No.: 13/023,898

(22) Filed: Feb. 9, 2011

(30) Foreign Application Priority Data
Feb. 17, 2010 (KR) 10-2010-0014319

(51) Int. Cl. G09G 5/10

(52) U.S. Cl. 345/690

(57) ABSTRACT

A method of displaying an image for a self-luminescence display includes determining loads by channels of an input image frame, estimating a display brightness of the input image frame using a relationship between the loads predetermined by channels and a change of the display brightness, correcting a luminance value of the image frame to correspond to the estimated brightness, and displaying the luminance-corrected image frame.

### PRIORITY

This application claims priority under 35 U.S.C. §119(a) to an application entitled “Method And Apparatus For Displaying Image For Self-Luminescence Display” filed in the Korean Intellectual Property Office on Feb. 17, 2010, and assigned Serial No. 10-2010-0014319, the entire disclosure of which is incorporated herein by reference.

### BACKGROUND OF THE INVENTION

1. Field of the Invention

The present invention relates generally to a self-luminescence display, and more particularly to a method and apparatus for displaying an image for a self-luminescence display.

2. Description of the Related Art

A self-luminescence display has a quicker moving image response speed and a superior color reproduction range and contrast ratio as compared to a Liquid Crystal Display (LCD), and is often used in a portable multimedia terminal instead of the LCD. Such a self-luminescence display consumes 30% or more power than is consumed in a portable terminal. Additionally, power consumption of the self-luminescence display depending on change of brightness of an image has a considerably great effect on the power consumption of the whole portable terminal.

In order to reduce the power consumed by an LCD in a portable terminal utilizing LCD, a method has been used, which lowers the brightness of a backlight having relatively high power consumption by analyzing the luminance of a current image and correcting the luminance of the image. However, the self-luminescence display is not provided with any separate backlight, and instead self-luminescence elements, that constitute pixels of the display, emit light. Accordingly, the power reduction method used in the LCD may not be adopted in the self-luminescence display, and there is a need for research in schemes for reducing the power consumed in driving the self-luminescence display.

### SUMMARY OF THE INVENTION

Accordingly, the present invention has been made to solve the above-mentioned problems occurring in the prior art, and the present invention provides a method and apparatus for displaying an image for a self-luminescence display, which can reduce the power consumption while constantly maintaining the brightness of an image frame that is output through the self-luminescence display.

In accordance with an aspect of the present invention, there is provided a method of displaying an image for a self-luminescence display, which includes determining loads by channels of an input image frame; estimating a display brightness of the input image frame using a relationship between the loads predetermined by channels and a change of the display brightness; correcting a luminance value of the image frame to correspond to the estimated brightness; and displaying the luminance-corrected image frame.

In accordance with another aspect of the present invention, there is provided an apparatus for displaying an image for a self-luminescence display, which includes a frame buffer temporarily storing an input image frame; a memory unit predefining and storing a relationship between loads by channels of the image frame and a display brightness; a luminance estimation unit determining the loads by channels of the image frame, and estimating the display brightness using the relationship between the loads by channels pre-stored in the memory and the display brightness; and a luminance correction unit receiving a display brightness estimation value from the luminance estimation unit, and correcting the luminance of the image frame to correspond to the luminance estimation value.

According to the present invention, the power consumed by the self-luminescence display can be reduced while constantly maintaining the brightness of the image frame using the characteristics of the self-luminescence display.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of an image driving apparatus for a self-luminescence display according to an embodiment of the present invention;

FIG. 2 is a diagram illustrating an example of loads by channels of the self-luminescence display;

FIG. 3 is a diagram illustrating an example of loads by channels of the self-luminescence display;

FIG. 4 is a graph illustrating an example of brightness characteristics for loads by channels of the self-luminescence display; and

FIG. 5 is a flowchart illustrating the order of a method of displaying an image for a self-luminescence display according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, various specific definitions are provided only to help general understanding of the present invention, and it is apparent to those skilled in the art that the present invention can be implemented without such definitions. Further, in the following description of the present invention, a detailed description of known functions and configurations incorporated herein will be omitted to avoid obscuring the subject matter of the present invention.

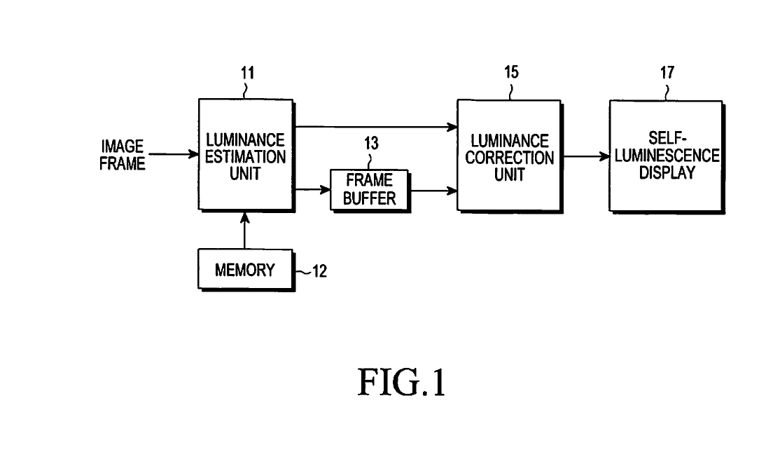

FIG. 1 is a block diagram illustrating the configuration of an image driving apparatus for a self-luminescence display according to an embodiment of the present invention. Referring to FIG. 1, an image driving apparatus for a self-luminescence display includes a luminescence estimation unit 11, a memory 12, a frame buffer 13, a luminance correction unit 15, and a self-luminescence display 17.

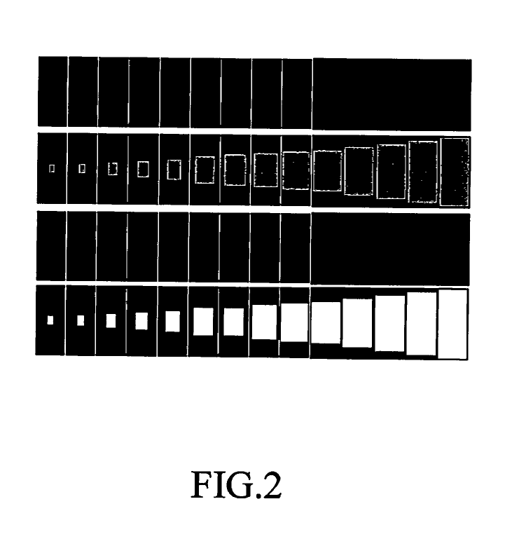

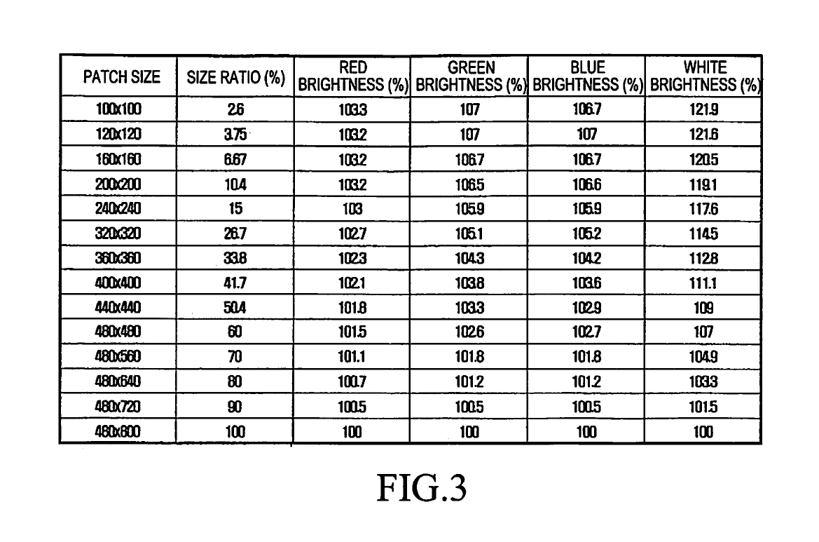

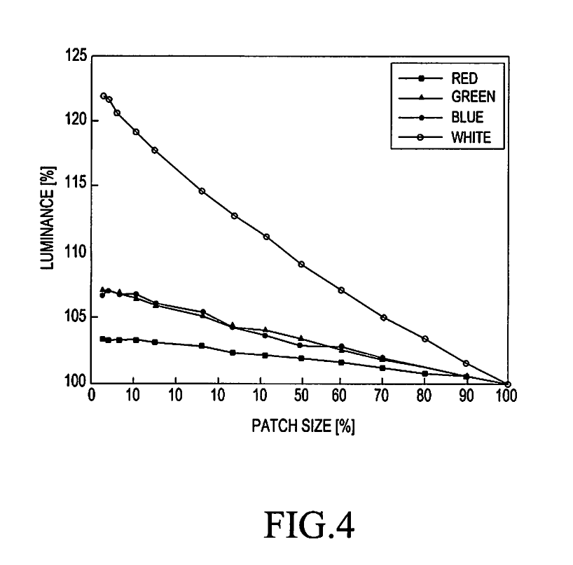

The self-luminescence display 17 has a characteristic that the brightness of light is changed according to a load of an output image frame. For example, referring to FIG. 2 illustrating the characteristics of the self-luminescence display 17, the self-luminescence display 17, to which red (R), green (G), blue (B), and white (W) components are output, has the characteristics that the brightness of self-luminescence elements becomes relatively higher when the red, green, blue, and white components are output to a portion of the self-luminescence display 17 rather than when the red, green, blue, and white components are output to the whole of the self-luminescence display 17. That is, as exemplified in FIGS. 3 and 4, if it is assumed that the red, green, blue, and white components with respective patch sizes are output to the self-luminescence display 17 with a pixel size of 480×800, the brightness of the self-luminescence elements becomes relatively higher when the red, green, blue, and white components are output to only a portion of the self-luminescence display 17 as compared to where the red, green, blue, and white components are output to the whole of the light-luminescence display 17 (100%). For example, if the patch size is 100×100, the brightness of the self-brightness elements of the red, green, blue, and white components becomes 103.3%, 107%, 106.7%, and 121.9%, respectively, in comparison to where the reference patch size is 480×800.

Further, in addition to the characteristics of the self-luminescence display 17, the power consumed by the display may be diversely changed according to a display manufacturing method, display size, display pixel structure, and the like. Accordingly, in order to determine the brightness of the self-luminescence elements more accurately through reflection of the characteristics of the display, a table that defines the relationship between the loads by channels and the display brightness based on the display size, and the like, is pre-stored in the memory 12.

Further, in order to correct the luminance value of the image frame through reflection of the brightness of the self-luminescence elements provided in the self-luminescence display 17, the luminance estimation unit 11 according to an embodiment of the present invention determines the loads by channels of the image frame to be output to the self-luminescence display 17. For example, the loads by channels of the image frame to be output to the self-luminescence display 17 can be the ratio of the turned-on state of the self-luminescence elements of red, green, blue, and white components provided in the self-luminescence display 17. Then, the luminance estimation unit 11 estimates the display brightness of the input image frame based on the relationship between the loads by channels pre-stored in the memory 12 and the display brightness.

The frame buffer 13 temporarily stores the input image frame. The luminance correction unit 15 receives a display brightness estimation value from the luminance estimation unit 11, corrects the luminance value of the image frame so that the output values of the red, green, blue, and white components included in the image frame are reduced to correspond to the increment of the display brightness, and then outputs the corrected output values of the red, green, blue, and white components to the self-luminescence display 17. For example, if the display brightness estimation value of the green component is 110% and the output value of the green component included in the image frame is 200, the output value of the green component included in the image frame is corrected and lowered by 10% and thus set to 180.

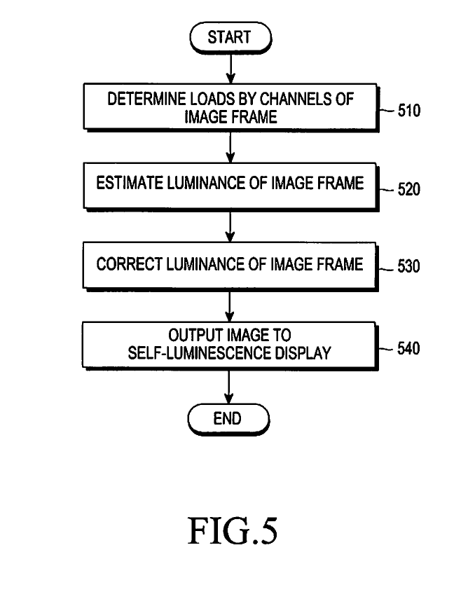

FIG. 5 is a flowchart illustrating the order of a method of displaying an image for a self-luminescence display according to an embodiment of the present invention. Referring to FIG. 5, first, in Step 510, in order to correct the luminance value of the image frame through reflection of the brightness of the self-luminescence display, the loads by channels of the image frame to be output to the self-luminescence display, that is, the ratio of the turned-on state of the self-luminescence elements of red, green, blue, and white components provided in the self-luminescence display, are determined. In Step 520, the display brightness of the input image frame is estimated based on the relationship between the pre-stored loads by channels and the display brightness.

In Step 530, the input image frame is temporarily stored, and using the display brightness estimation value, the luminance value of the image frame is corrected so that the output values of the red, green, blue, and white components included in the image frame are reduced to correspond to the increment of the display brightness. Then, in Step 540, the corrected output values of the red, green, blue, and white components are output to the self-luminescence display 17. For example, if the display brightness estimation value of the green component is 110% and the output value of the green component included in the image frame is 200, the display brightness value of 110% is estimated in Step 520, and the output value of the green component included in the image frame is corrected to be lowered by 10% to be set to 180 in Step 530. In the same method as steps 520 and 530, the output values of the red and green components are corrected.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of displaying an image for a self-luminescence display, comprising:
determining loads by channels of an input image frame;
estimating a display brightness of the input image frame using a relationship between the loads predetermined by channels and a change of the display brightness;
correcting a luminance value of the image frame to correspond to the estimated brightness; and
displaying the luminance-corrected image frame.

2. The method of displaying an image as claimed in claim 1, wherein the channels include channels of red (R), green (G), and blue (B) components.

3. The method of displaying an image as claimed in claim 1, wherein the loads indicate driving ratios of the self-luminescence element by channels of the self-luminescence display.

4. An apparatus for displaying an image for a self-luminescence display, comprising:
a frame buffer temporarily storing an input image frame;
a memory unit predefining and storing a relationship between loads by channels of the image frame and a display brightness;
a luminance estimation unit determining the loads by channels of the image frame, and estimating the display brightness using the relationship between the loads by channels pre-stored in the memory and the display brightness; and
a luminance correction unit receiving a display brightness estimation value from the luminance estimation unit, and correcting the luminance of the image frame to correspond to the luminance estimation value.

5. The apparatus for displaying an image as claimed in claim 4, wherein the channels include channels of red (R), green (G), and blue (B) components.

6. The apparatus for displaying an image as claimed in claim 4, wherein the loads indicate driving ratios of the self-luminescence element by channels of the self-luminescence display.
